(19) United States
(12) Patent Application Publication
(10) Pub. No.: US 2016/0196348 A1
(43) Pub. Date: Jul. 7, 2016

(54) RE-ORDERING SEARCH RESULTS BASED ON VIEWED PAGES

(71) Applicant: International Business Machines Corporation, Armonk, NY (US)

(72) Inventors: Adrian X. Rodriguez, Durham, NC (US); John L. Ryding, III, Raleigh, NC (US); Kristin R. Whetstone, Raleigh, NC (US); Eric Woods, Durham, NC (US)

(21) Appl. No.: 14/591,102

(22) Filed: Jan. 7, 2015

(51) Int. Cl. G06F 17/30

(52) U.S. Cl. CPC G06F 17/30864; G06F 17/3097

(57) ABSTRACT

A method for adjusting search results based on viewed pages is provided. The method may include receiving at least one search request within a plurality of search requests. The method may also include identifying first and second variations of the at least one search request, wherein the first variation is different from the second variation. The method may further include searching for the first and second variations. Additionally, the method may include receiving a plurality of first and second variation search results. The method may also include presenting portions of the received plurality of first and second variation search results, wherein a first and second remainder of the first and second variations are not presented, respectively. The method may further include applying a criteria to adjust the first remainder and the second remainder to be presented, wherein the adjusting is responsive to detecting at least one user action.

### BACKGROUND

The present invention relates generally to the field of computing, and more specifically, to generating and re-ordering search results based on multiple potential search terms.

Web search engines are useful tools for retrieving content on the web. Generally, a web search engine includes a user interface that allows a user to access information on the internet by performing keyword or phrase searches. A search engine may also maintain data about many web pages, such as extracted text and other information used to index the content of a corresponding web page. A user may typically begin a search by querying a search engine through a web browser and typing a keyword or phrase in a search box. Then, the browser may recommend keywords or phrases by suggesting a term, or as part of an auto complete feature with real-time dynamic capabilities that predicts a term as the user types information into the search box and changes as the user continues typing. Once the user selects a keyword or phrase, the search engine closely matches that keyword or phrase to corresponding web page data indexed by the search engine and generates results.

### SUMMARY

A method for adjusting a plurality of search results based on a plurality of viewed pages is provided. The method may include receiving at least one search request within a plurality of search requests. The method may also include identifying a first variation of the at least one search request and a second variation of at the least one search request, wherein the first variation is different from the second variation. The method may further include searching for the first variation and the second variation within a plurality sources. Additionally, the method may include receiving a plurality of first variation search results based on the searched first variation, and receiving a plurality of second variation search results based on the searched second variation. The method may also include presenting a portion of the received plurality of first variation search results and the received plurality of second variation search results, wherein a first remainder of the first variation is not presented and a second remainder of the second variation is not presented. The method may further include applying a criteria to adjust the first remainder and the second remainder to be presented, wherein the adjusting is responsive to detecting at least one user action.

A computer system for adjusting a plurality of search results based on a plurality of viewed pages is provided. The computer system may include one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method. The method may include receiving at least one search request within a plurality of search requests. The method may also include identifying a first variation of the at least one search request and a second variation of at the least one search request, wherein the first variation is different from the second variation. The method may further include searching for the first variation and the second variation within a plurality sources. Additionally, the method may include receiving a plurality of first variation search results based on the searched first variation, and receiving a plurality of second variation search results based on the searched second variation. The method may also include presenting a portion of the received plurality of first variation search results and the received plurality of second variation search results, wherein a first remainder of the first variation is not presented and a second remainder of the second variation is not presented. The method may further include applying a criteria to adjust the first remainder and the second remainder to be presented, wherein the adjusting is responsive to detecting at least one user action.

A computer program product for extraction and enrichment of a procedure from a document is provided. The computer program product may include one or more computer-readable storage devices and program instructions stored on at least one of the one or more tangible storage devices, the program instructions executable by a processor. The computer program product may include program instructions to receive at least one search request within a plurality of search requests. The computer program product may also include program instructions to identify a first variation of the at least one search request and a second variation of at the least one search request, wherein the first variation is different from the second variation. The computer program product may further include program instructions to search for the first variation and the second variation within a plurality sources, wherein the searching is performed in real-time. Additionally, the computer program product may include program instructions to receive a plurality of first variation search results based on the searched first variation, and to receive a plurality of second variation search results based on the searched second variation. The computer program product may also include program instructions to present a portion of the received plurality of first variation search results and the received plurality of second variation search results, wherein a first remainder of the first variation is not presented and a second remainder of the second variation is not presented. The computer program product may further include program instructions to apply a criteria to adjust the first remainder and the second remainder to be presented, wherein the adjusting is responsive to detecting at least one user action.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program for generating search results on multiple potential search terms and re-ordering the search results based on viewed web pages; and

FIG. 3 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly, to generating search results based on multiple potential search terms. The following described exemplary embodiments provide a system, method and program product for generating search results based on multiple potential search terms and re-ordering those results in response to web pages viewed by the user. Additionally, the present embodiment has the capacity to improve the technical field of web searching by generating search results based on multiple search terms and re-ordering the results based on viewed web pages.

As previously described with respect to web searching, a web search engine typically includes a user interface that allows a user to access information on the internet by performing keyword or phrase searches. For example, a user may typically begin a search by querying a search engine through a web browser, such as Google® (Google and all Google-based trademarks and logos are trademarks or registered trademarks of Google, Inc. and/or its affiliates) or Yahoo!® (Yahoo and all Yahoo-based trademarks and logos are trademarks or registered trademarks of Yahoo Inc. and/or its affiliates). Then, the browser may recommend keywords or phrases by suggesting a term, or as part of an auto complete feature with real-time dynamic capabilities that predicts a term as the user types information into the search box and changes as the user continues typing. The search results may be presented in a standard list determined by the keyword term selected by the user. The user may be able to view each individual result by clicking on a hyperlink to the web page and return back to the same search results list as needed. However, the search is being performed on just a single keyword term. Therefore, when a user makes a keyword term selection the generated search results are limited to the keyword term selected. As such, it may be advantageous, among other things, to generate search results on multiple potential search terms and re-order the search results based on viewed web pages.

According to at least one embodiment of the present invention, a search may be performed on multiple potential search terms simultaneously. In one embodiment, a keyword term may produce other potential search terms. Then, according to one implementation, a search may be simultaneously performed on the keyword term as well as the other potential search terms, such as terms recommended by a browser or predicted from an auto complete feature with real-time capabilities. Furthermore, according to one implementation, the search results may include a list of results related to the keyword term intermingled with results related to the other potential search terms. Also, according to one implementation, the search results may be re-ordered and further narrowed based on the viewed results.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for generating search results based on multiple potential search terms and re-ordering those results in response to web pages viewed by the user.

According to at least one implementation, multiple potential search terms may be generated as a user types a keyword term into a search box. For example, multiple potential search terms may be generated from spelling corrections of the keyword term and/or by a real-time auto-complete feature predicting what the user will type next. Then, a search may be simultaneously performed on the keyword term and each of the multiple potential search terms without needing the user to choose between them. Therefore, embodiments of the present invention may not only return search results for the keyword term typed in by the user, but may simultaneously return search results for the multiple potential search terms. Furthermore, the generated search results may be a list of search results from the keyword term intermingled with search results from each of the multiple potential search terms. As such, embodiments of the present invention may include simultaneously generating and displaying search results for a keyword term and multiple potential search terms together.

Additionally, embodiments of the present invention may re-order the generated search results based on viewed web pages. According to at least one implementation, the generated search results may be narrowed to include search results more closely related to the web pages viewed by the user. For example, if a user viewed search results linked to one of the multiple potential search terms, more search results from that search term may be displayed.

Furthermore, the search results that may not be viewed by the user, may not be included in the generated search results or may not be displayed in future results for the keyword term that was searched. As such, when the user clicks on the search results and does not find what they are looking for, the keywords that were included in the search results may also be narrowed.

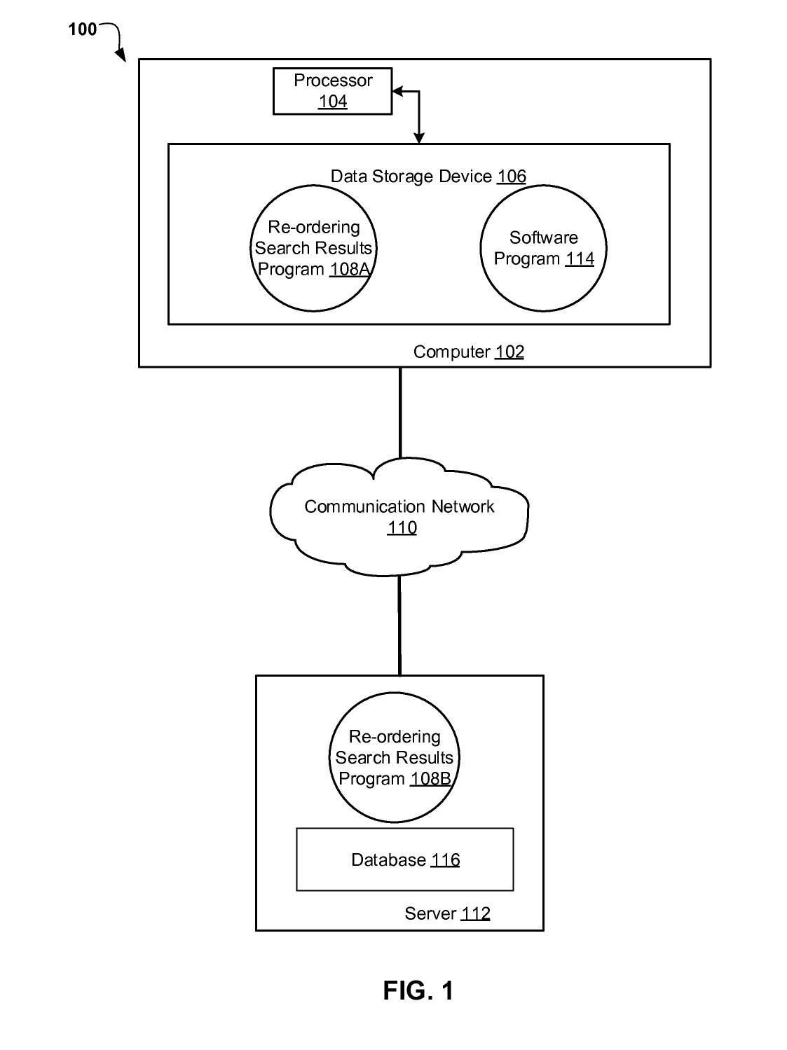

Referring now to FIG. 1, an exemplary networked computer environment 100 in accordance with one embodiment is depicted. The networked computer environment 100 may include a computer 102 with a processor 104 and a data storage device 106 that is enabled to run a re-ordering search results program 108A and a software program 114. The software program 114 may be an application program such as a search query program, an internet browser, and an email program. The re-ordering search results program 108A may communicate with the software program 114. The networked computer environment 100 may also include a server 112 that is enabled to run a re-ordering search results program 108B and a communication network 110. The networked computer environment 100 may include a plurality of computers 102 and servers 112, only one of which is shown for illustrative brevity.

According to at least one implementation, the present embodiment may also include a database 116, which may be running on server 112. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

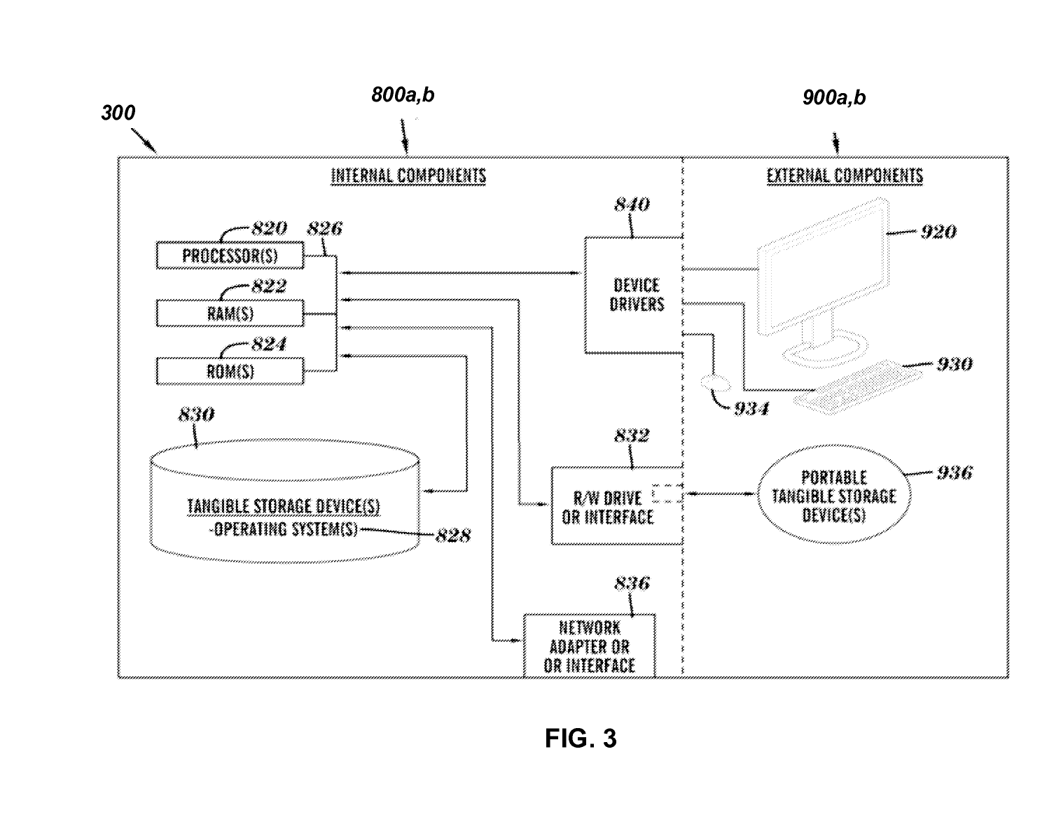

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program and accessing a network.

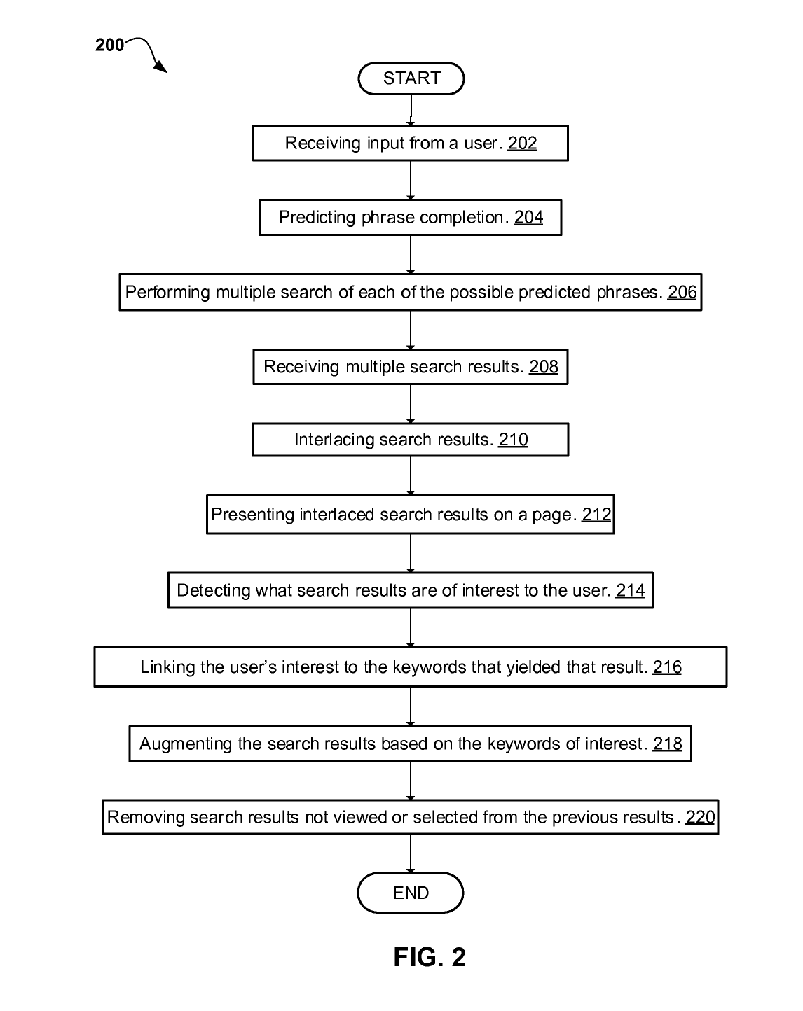

According to the present embodiment, a program, such as a re-ordering search results program 108A and 108B may run on the client computer 102 or on the server computer 112. The re-ordering search results program 108A, 108B may anticipate user search queries, perform user search queries, and present the query results to the user. For example, a user using a computer, such as computer 102, may use a software application program 114, such as Firefox® (Firefox and all Firefox-based trademarks and logos are trademarks or registered trademarks of Mozilla and/or its affiliates), that interacts with the re-ordering search results program 108A, 108B and a database 116 to anticipate user search query terms, perform the search query based on those terms, and present the results. The re-ordering search results program method is explained in further detail below with respect to FIG. 2.

Referring now to FIG. 2, an operational flowchart illustrates the steps carried out by a program for generating search results on multiple potential search terms and re-ordering the search results based on viewed web pages. As previously described, the re-ordering search results program 108A, 108B (FIG. 1) may be implemented as running on a client computer 102 (FIG. 1) or server computer 112 (FIG. 1). According to at least one embodiment, the program may generate search results on multiple potential search terms and re-order the search results based on viewed web pages. The implementation for the steps in generating and re-ordering search results on multiple potential search terms are described in more detail below.

At 202, the re-ordering search results program 108A, 108B may receive input from a user initiating a search. The received input may be a search term. For example, client computer 102 (FIG. 1), which may be a mobile device, may be used by the user to access a software application program 114 (FIG. 1), such as a web browser (i.e. Firefox®), to query a search engine and input a search term, such as “ibm”. The re-ordering search results program 108A, 108B may then interact with the software application program 114 (FIG. 1) to receive the search term.

Next, at 204, the re-ordering search results program 108A, 108B may predict phrase completion. As such, the re-ordering search results program 108A, 108B may predict other search query terms based on the input from the user. The predicted search query terms may, for example, be based on spelling corrections, an auto complete feature, profile information, location-based suggestions, crowd-sourced suggestions, and trending keywords. For example, the re-ordering search results program 108A, 108B may receive the search query term “ibn” from a user. As a spelling correction, the re-ordering search results program 108A, 108B may predict that the user meant “ibm”, and may also predict other potential search query terms such as “ibm jobs” and “ibm watson”. Thus, as the user types in a search query term, the re-ordering search results program 108A, 108B may predict other multiple potential search query terms.

Then, at 206, the re-ordering search results program 108A, 108B may perform multiple searches of each of the possible predicted phrases. Therefore, a real-time search may be simultaneously performed on the search query term, which was inputted by the user, as well as the other multiple potential search query terms predicted at the previous step 204. For example, the re-ordering search results program 108A, 108B may receive the search query term “ibn” from the user using client computer 102 (FIG. 1). The re-ordering search results program 108A, 108B may then predict a spelling correction “ibm”, and may also predict other multiple potential search query terms, such as “ibm jobs and “ibm watson”. Then, a real-time search may be simultaneously performed by the re-ordering search results program 108A, 108B on “ibn”, “ibm”, “ibm jobs”, and “ibm watson”. Thus, according to at least one embodiment of the present invention, multiple concurrent searches may be performed on each individual search query term, which may include the search query term typed in by the user and the predicted variations thereof.

Next, at 208, the re-ordering search results program 108A, 108B may receive multiple search query results for each search query term. As previously described, based on input from the user, at the previous step 202, the re-ordering search results program 108A, 108B may predict other multiple potential search query terms. At previously described at step 206, the re-ordering search results program 108A, 108B may simultaneously perform a search on the search query term inputted by the user and on each of the predicted search query terms. As such, based on the simultaneously performed search, search query results may be received for each individual search query term. For example, the re-ordering search results program 108A, 108B may receive the search query term “ib”, then may use an auto-complete feature to predict the search query term “ibm”, and may also predict other multiple potential search query terms such as “ibm jobs and “ibm watson”. Thereafter, the re-ordering search results program 108A, 108B may simultaneously perform a real-time search on “ib”, “ibm”, “ibm jobs”, and “ibm watson”. Therefore, the re-ordering search results program 108A, 108B may produce multiple search results for each search query term “ib”, “ibm”, “ibm jobs”, and “ibm watson”. Thus, according to embodiments, real-time search results for each individual search query term may be generated.

Then, at 210, the re-ordering search results program 108A, 108B may interlace the received search query results. For example, the re-ordering search results program 108A, 108B may produce search query results 1, 2, 3, 4, 5 for “ibm”, and search query results a, b, c, d, e for “ibm jobs”. The re-ordering search results program 108A, 108B may then interlace the search query results together as such: 1, a, 2, b, 3, c, 4, d, 5, e. The search query results for the search query terms may be interlaced in different ways and may be based on, for example, the similarity of the predicted search query terms to the inputted search query term, the popularity of the site and/or topic, and the likelihood of the predicted search query terms being correct.

Next, at 212, the re-ordering search results program 108A, 108B may present the interlaced search query results to the user on a device, such as client computer 102 (FIG. 1). As, the re-ordering search results program 108A, 108B may present at least one result for each individual search query term. Furthermore, subsets of the interlaced search query results may be presented on multiple pages. For example, search query results for the search query terms “ib” and “ibm” may be presented on page 1 of the search results page, and search query results for the search query terms “ibm jobs” and “ibm watson” may be presented on page 2. According to embodiments, once input is received from the user at the previous step 202, the re-ordering search results program 108A, 108B may present a real-time interlaced set of search query results to the user, thereby allowing the user to choose to stop inputting a search term and start browsing through the real-time interlaced search results. For example, as the re-ordering search results program 108A, 108B receives the search query term “ib”, a real-time search may be performed on the inputted and predicted search query terms, and interlaced search query results may be presented without needing further input from the user.

Then, at 214, the re-ordering search results program 108A, 108B may detect what search query results are of interest to the user. As such, the re-ordering search results program 108A, 108B may determine a perceived value to assign to individual search query results based on the detected interest of the user. According to at least one implementation of the present embodiment, the re-ordering search results program 108A, 108B may detect the user's interest in a search query result based on such attributes as the description of the search query result, the user's time spent with the search query result, the user's speed in scrolling to the next search query result, the user viewing the search query result, the user viewing links within the search query result, and/or the user navigating away from the search query result. Furthermore, the re-ordering search results program 108A, 108B may detect the user's interest in multiple search query results related to different search query terms.

Next, at 216, the re-ordering search results program 108A, 108B may link the determined interest of the user to the keywords of the search query terms that yielded the interested search query results. For example, after interlacing and presenting search query results for the search query term “ib”, the re-ordering search results program 108A, 108B may detect that the user selected search query results more related to the search query term “ibm watson”. Therefore, the re-ordering search results program 108A, 108B may link the user's interest to the keywords that yielded those search query results, here “ibm watson”. Furthermore the re-ordering search results program 108A, 108B may link the user's interest to keywords of multiple search query terms.

Then, at 218, the re-ordering search results program 108A, 108B may augment the search query results based on the keywords of interest. As stated in the previous example, the re-ordering search results program 108A, 108B may detect that the user selected search query results more related to the search query term “ibm watson”. As such, after linking the user's interest to the keywords that yielded those search query results, the re-ordering search results program 108A, 108B may augment the interlaced search query results so that more results from “ibm watson” may be presented to the user. Therefore, when the user returns from selecting a search query result to the original page of interlaced search query results, more “ibm watson” search query results may be added. The added “ibm watson” search query results may, for example, be presented on the first page with the originally viewed interlaced search query results or on the following interlaced search query results pages. For each individual search query result detected by the re-ordering search results program 108A, 108B to be of interest to the user, more search query results from those search query terms may be presented.

Next, at 220, the re-ordering search results program 108A, 108B may remove search query results that were not viewed or selected by the user from the interlaced search query results pages. As previously described with the previous step 218, when the re-ordering search results program 108A, 108B has linked the user's interest to one or more search query results, more search query results from those search query terms may be presented to the user. Conversely, for the search query results not viewed or selected by the user, or not linked to the search query terms of interest to the user, the re-ordering search results program 108A, 108B may remove those search query results from the interlaced search results pages.

It may be appreciated that FIG. 2 provides only an illustration of one implementation and does not imply any limitations with regard to how different embodiments may be implemented. Many modifications to the depicted environments may be made based on design and implementation requirements. For example, as previously described, the search query results not viewed by the user may be removed from the interlaced search results.

FIG. 3 is a block diagram of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 3. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the software program 114, the Re-ordering Search Results Program 108A (FIG. 1) in client computer 102, and the Re-ordering Search Results Program 108B in network server computer 112 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as re-ordering search results program 108A and 108B, can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The re-ordering search results program 108A and software program 114 in client computer 102, and the re-ordering search results program 108B in network server 112 can be downloaded to client computer 102 from an external computer via a network (for example, the Internet, a local area network or other, wide area network) and respective network adapters or interfaces 836. From the network adapters or interfaces 836, the re-ordering search results program 108A and software program 114 in client computer 102 and the re-ordering search results program 108B in network server computer 112 are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for adjusting a plurality of search results based on a plurality of viewed pages, the method comprising:
receiving at least one search request within a plurality of search requests;
identifying a first variation of the at least one search request and a second variation of at the least one search request, wherein the first variation is different from the second variation;
searching for the first variation and the second variation within a plurality of sources;
receiving a plurality of first variation search results based on the searched first variation;
receiving a plurality of second variation search results based on the searched second variation;
presenting a portion of the received plurality of first variation search results and the received plurality of second variation search results, wherein a first remainder of the first variation is not presented and a second remainder of the second variation is not presented; and
applying a criteria to adjust the first remainder and the second remainder to be presented, wherein the adjusting is responsive to detecting at least one user action.

2. The method of claim 1, wherein the at least one search request is a partial entry of text and the first variation is a predicted completion of the text.

3. The method of claim 2, wherein the predicted completion is selected from a group comprising a plurality of spelling corrections, an auto-complete feature, a plurality of location based suggestions, a plurality of crowd-sourced suggestions, and a plurality of trending keywords.

4. The method of claim 1, wherein the criteria is selected from a group comprising at least one of a similarity, a popularity, a prediction, a plurality of detected user actions, an artificial intelligence, a feedback based on history, and a plurality of crowd-sourced accumulations.

5. The method of claim 1, wherein the searching for the first variation and the second variation within a plurality of sources is performed in real-time.

6. The method of claim 1, wherein the first portion of the received plurality of first variation search results and the second portion of the received plurality of second variation search results are removed.

7. The method of claim 1, wherein the detecting the at least one user action comprises at least one of a determination of a plurality of time spent with at least one search result within the plurality of search results, a speed in scrolling through the plurality of search results, and a plurality of viewed search results within the plurality of search results.

8. A computer system for adjusting a plurality of search results based on a plurality of viewed pages, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving at least one search request within a plurality of search requests;
identifying a first variation of the at least one search request and a second variation of at the least one search request, wherein the first variation is different from the second variation;
searching for the first variation and the second variation within a plurality sources;
receiving a plurality of first variation search results based on the searched first variation;
receiving a plurality of second variation search results based on the searched second variation;
presenting a portion of the received plurality of first variation search results and the received plurality of second variation search results, wherein a first remainder of the first variation is not presented and a second remainder of the second variation is not presented; and
applying a criteria to adjust the first remainder and the second remainder to be presented, wherein the adjusting is responsive to detecting at least one user action.

9. The computer system of claim 8, wherein the at least one search request is a partial entry of text and the first variation is a predicted completion of the text.

10. The computer system of claim 9, wherein the predicted completion is selected from a group comprising a plurality of spelling corrections, an auto-complete feature, a plurality of location based suggestions, a plurality of crowd-sourced suggestions, and a plurality of trending keywords.

11. The computer system of claim 8, wherein the criteria is selected from a group comprising at least one of a similarity, a popularity, a prediction, a plurality of detected user actions, an artificial intelligence, a feedback based on history, and a plurality of crowd-sourced accumulations.

12. The computer system of claim 8, wherein the searching for the first variation and the second variation within a plurality of sources is performed in real-time.

13. The computer system of claim 8, wherein the first portion of the received plurality of first variation search results and the second portion of the received plurality of second variation search results are removed.

14. The computer system of claim 8, wherein the detecting the at least one user action comprises at least one of a determination of a plurality of time spent with at least one search result within the plurality of search results, a speed in scrolling through the plurality of search results, and a plurality of viewed search results within the plurality of search results.

15. A computer program product for adjusting a plurality of search results based on a plurality of viewed pages, comprising:
one or more computer-readable storage devices and program instructions stored on at least one of the one or more tangible storage devices, the program instructions executable by a processor, the program instructions comprising:
program instructions to receive at least one search request within a plurality of search requests;
program instructions to identify a first variation of the at least one search request and a second variation of at the least one search request, wherein the first variation is different from the second variation;
program instructions to search for the first variation and the second variation within a plurality sources;
program instructions to receive a plurality of first variation search results based on the searched first variation;
program instructions to receive a plurality of second variation search results based on the searched second variation;
program instructions to present a portion of the received plurality of first variation search results and the received plurality of second variation search results, wherein a first remainder of the first variation is not presented and a second remainder of the second variation is not presented; and
program instructions to apply a criteria to adjust the first remainder and the second remainder to be presented, wherein the adjusting is responsive to detecting at least one user action.

16. The computer program product of claim 15, wherein the at least one search request is a partial entry of text and the first variation is a predicted completion of the text.

17. The computer program product of claim 15, wherein the predicted completion is selected from a group comprising a plurality of spelling corrections, an auto-complete feature, a plurality of location based suggestions, a plurality of crowd-sourced suggestions, and a plurality of trending keywords.

18. The computer program product of claim 15, wherein the criteria is selected from a group comprising at least one of a similarity, a popularity, a prediction, a plurality of detected user actions, an artificial intelligence, a feedback based on history, and a plurality of crowd-sourced accumulations.

19. The computer program product of claim 15, wherein the first portion of the received plurality of first variation search results and the second portion of the received plurality of second variation search results are removed.

20. The computer program product of claim 15, wherein the detecting the at least one user action comprises at least one of a determination of a plurality of time spent with at least one search result within the plurality of search results, a speed in scrolling through the plurality of search results, and a plurality of viewed search results within the plurality of search results.
